(19) United States
(12) Patent Application Publication
(10) Pub. No.: US 2009/0325018 A1
(43) Pub. Date: Dec. 31, 2009

(54) FIXED INSTALLATION FOR SUPPLYING ELECTRIC POWER COMPRISING A FUEL CELL

(76) Inventor: Patrick Sanglan, Seyssins (FR)

Correspondence Address: AIR LIQUIDE;Intellectual Property, 2700 POST OAK BOULEVARD, SUITE 1800, HOUSTON, TX, 77056, US

(21) Appl. No.: 12/066,700

(22) PCT Filed: Aug. 1, 2006
(86) PCT No.: PCT/FR06/50773

§ 371 Date: Sep. 10, 2009

(30) Foreign Application Priority Data
Sep. 13, 2005 (FR) 0552754

(51) Int. Cl. H01M 2/02; H01M 8/10

(52) U.S. Cl. 429/30; 429/34

(57) ABSTRACT

The invention concerns a fixed installation for supplying electric power comprising a fuel cell (2) arranged in a chamber (1) set on the ground (5) via support blocks (6), the air intake (11) in the chamber, advantageously provided with a fan (12), emerging into the volume (8) between the floor (7) of the chamber and the ground (5), said volume being peripherally closed by skirts (9) one of which includes at least one air intake provided with an air filter (10).

The present invention relates to fixed installations for supplying electrical power, comprising a fuel cell supplied with air and with fuel, positioned in an enclosed space.

It is known that fuel cells, particularly those of the proton exchange membrane (PEM) type are sensitive to temperature and generally include cooling means that work by circulating fluid.

It is an object of the present invention to propose a stationary fuel cell installation that allows the temperature to be regulated simply and efficiently and at very low cost within a broad range of weather conditions.

To do this, according to one feature of the invention, the enclosed space containing the fuel cell is placed on the ground via support blocks, the air inlet into the enclosed space opening onto the volume between the enclosed space and the ground.

According to some more specific features of the invention:
the air inlet comprises a fan delivering into the enclosed space;
the volume between the enclosed space and the ground is closed around its periphery by skirts, one of these skirts comprising at least one inlet opening, advantageously fitted with a filter;
the ground underneath the enclosed space is covered with pebbles;
the floor of the enclosed space is made of a thermally insulating material.

Other features and advantages of the invention will become apparent from the following description of some embodiments which are given by way of entirely unlimiting illustration with reference to the attached drawing in which:

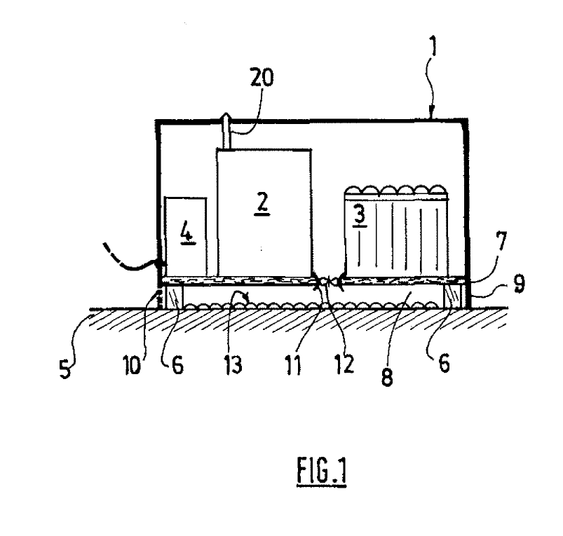

FIG. 1 is a schematic view in vertical section of an installation according to the invention.

As depicted schematically in FIG. 1, an installation according to the invention comprises, in an enclosed space 1, typically a “20-foot” (or larger) container, a fuel cell unit 2 of the PEM type using air and a fuel, typically hydrogen stored in a hydrogen cylinder rack 3, and an electrical control cabinet 4 controlling the cell and regulating the electrical current supplied.

According to the invention, the enclosed space 1 is placed on the ground 5 via at least four short blocks 6 so as to leave an intermediate volume 8 between the floor 7 of the enclosed space 1 and the ground 5. The under floor volume 8 is closed around the periphery by skirts 9 hanging down from the sides of the enclosed space 1, one of these skirts being formed with at least one inlet opening equipped with an air filter 10 to allow air to enter the volume 8.

The interior volume of the enclosed space 1 communicates with the intermediate volume 8 via a passage 11 formed in the floor 7 and fitted with a fan 12 thus sucking the ambient air via the inlet opening fitted with the filter 10, the tunnel formed by the intermediate volume 8, the passage 11, into the enclosed space 1 as far as the fans of the fuel cell unit 2. The exhaust gases from the fuel cell 2 are discharged to the exterior of the enclosed space through a chimney 20.

Advantageously, according to the invention, the surface of the ground 5 underneath the floor 7 is covered with a bed of washed pebbles 13 to prevent the ingress of dust and to increase the area for heat exchange with the ground. Furthermore, the floor 7 is advantageously made of solid wood, which displays good thermal inertia in order to provide screening at the top of the volume 8.

With an arrangement such as this, for a 20-foot container, an area measuring approximately 15 m² for exchange of heat with the ground becomes available for temperature-controlling the air entering the enclosed space and thus regulating the temperature of the fuel cell using the thermal inertia of the ground 5 without additional energy expenditure.

Although the invention has been described in conjunction with some particular embodiments, it is not in any way limited thereto but can be modified and varied in ways that will be obvious to a person skilled in the art within the scope of the claims which follow.

1-8. (canceled)

9. A fixed installation for supplying electrical power, comprising a fuel cell supplied with air and with fuel, positioned in an enclosed space, wherein the enclosed space is placed on the ground via support blocks, an air inlet into the enclosed space opening onto the volume between the enclosed space and the ground.

10. The installation of claim 9, wherein the air inlet comprises a fan delivering into the enclosed space.

11. The installation of claim 9, wherein the volume between the enclosed space and the ground is closed around its periphery by skirts, one of these skirts comprising at least one inlet opening.

12. The installation of claim 11, wherein the inlet opening comprises an air filter.

13. The installation of claim 9, wherein the ground underneath the enclosed space is covered with pebbles.

14. The installation of claim 9, wherein the floor of the enclosed space is made of a thermally insulating material.

15. The installation of claim 9, wherein the fuel cell is of the proton exchange membrane (PEM) type.

16. The installation of claim 9, wherein the fuel is hydrogen.
